(19) United States
(12) Patent Application Publication
(10) Pub. No.: US 2012/0287500 A1
(43) Pub. Date: Nov. 15, 2012

(54) OPTICAL LENS AND OPTICAL MICROSCOPE SYSTEM USING THE SAME

(76) Inventors: Ming-Teng Hsieh, New Taipei City (TW); Yi-Nan Chen, Taipei City (TW); Hsien-Wen Liu, Taoyuan County (TW)

(21) Appl. No.: 13/106,864

(22) Filed: May 13, 2011

(51) Int. Cl. G02B 21/02; G02B 3/02

(52) U.S. Cl. 359/368; 359/718

(57) ABSTRACT

An optical lens is provided in the present invention. The optical lens includes a first curved surface and an annular mask component on and in direct contact with the first curved surface, wherein the annular mask component shields a peripheral annular region of the optical lens from entry of light. The present invention further provides an optical microscope system using the same.

### BACKGROUND OF THE INVENTION

1. Field of the Invention

The present invention relates to an optical lens used in an optical microscope system, and more particularly, to an optical lens having an annular mask component for shielding a peripheral region of the optical lens from entry of light.

2. Description of the Prior Art

It is well known that an optical lens is an optical device with perfect or approximate axial symmetry which transmits and refracts light, converging or diverging the beam. When a beam formed by any set of parallel rays of light, of any spectral color wave, are directed onto a spherical convex surface of any transparent material, the light reflected therethrough will not provide an exact or punctual perfect focus, because of the spherical aberration phenomenon.

Generally speaking, spherical aberration is an optical effect that occurs due to the increased refraction of light rays when they strike a lens near its edge, in comparison with those that strike nearer the center. FIG. 1 is a schematic diagram showing spherical aberration phenomenon. As shown in FIG. 1, paraxial light ray 100 and peripheral light ray 102 are incident on a lens 104. Paraxial light ray 100 and peripheral light ray 102 do not unite accurately at a focus. The spherical aberration phenomenon results in reduced image sharpness. Therefore, spherical aberration phenomenon is still a problem needed to be overcome.

### SUMMARY OF THE INVENTION

It is one objective of the present invention to provide an optical lens with reduced spherical aberration effects and thus enhanced image sharpness.

According to one aspect of the claimed invention, an optical lens is provided. The optical lens includes a first curved surface and an annular mask component on and in direct contact with the first curved surface, wherein the annular mask component shields a peripheral annular region of the optical lens from entry of light.

According to another aspect of the claimed invention, an optical microscope system is provided. The optical microscope system includes an objective lens having a first curved surface and a projector lens having a second curved surface. At least one of the objective lens and the projector lens comprises an annular mask component on and in direct contact with the first curved surface or the second curved surface. The annular mask component shields a peripheral annular region of the objective lens or the projector lens from entry of light.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram of spherical aberration phenomenon.

FIG. 2 and FIG. 3 illustrate schematic diagrams of the optical lens according to the first embodiment of the present invention.

FIG. 4 illustrates a schematic diagram of the optical lens according to the second embodiment of the present invention.

FIG. 5 illustrates a schematic diagram of the optical lens according to the third embodiment of the present invention.

FIG. 6 illustrates a schematic diagram of the optical microscope system in the present invention.

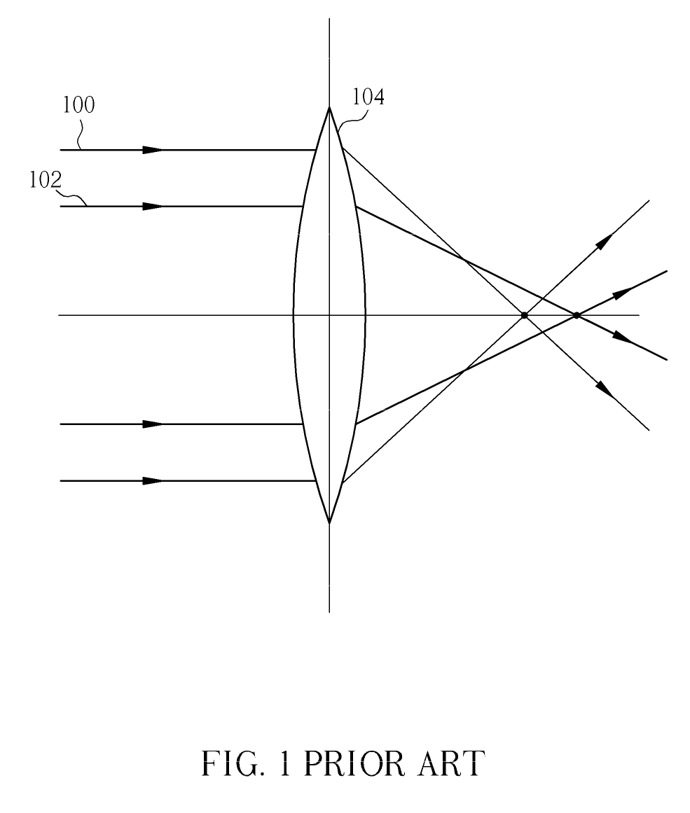

### DETAILED DESCRIPTION

To provide a better understanding of the presented invention, preferred embodiments will be made in detail. The preferred embodiments of the present invention are illustrated in the accompanying drawings with numbered elements.

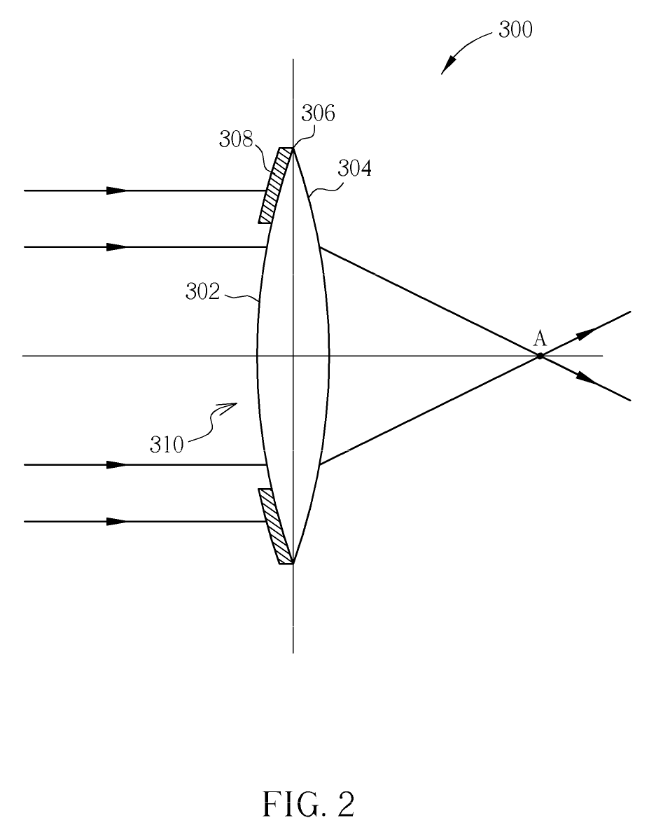

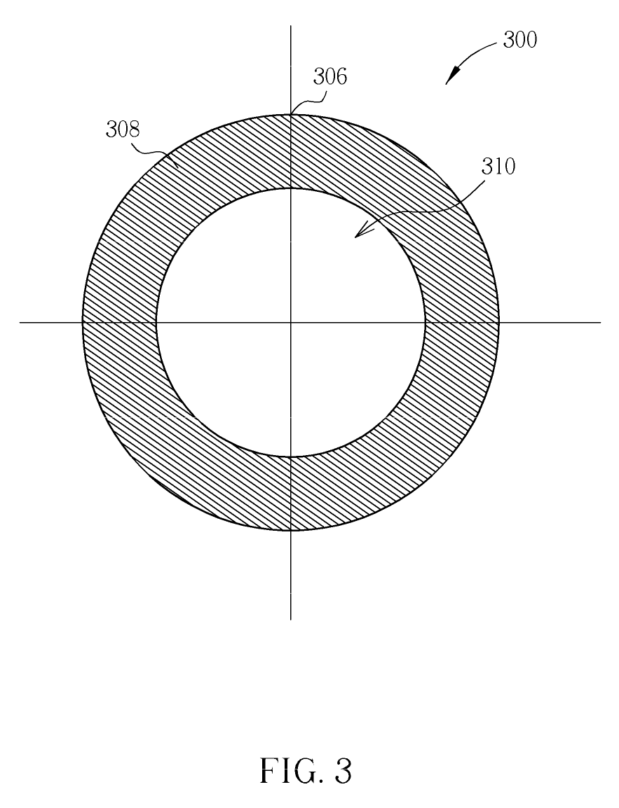

Please refer to FIG. 2 and FIG. 3, illustrating schematic diagrams of an optical lens 300 according to the first embodiment of the present invention. FIG. 2 shows the optical lens in a sectional view and FIG. 3 shows a front view of the optical lens 300 in FIG. 2. As shown in FIG. 2, the optical lens 300 includes a first curved surface 302, a second curved surface 304 and an edge 306. The first curved surface 302 and the second curved surface 304 are disposed opposite to each other and converge at the edge 306. In one embodiment, the first curved surface 302 and the second curved surface 304 are spherical surfaces having predetermined surface curvature values which can be the same or can be different. According to this embodiment, as shown in FIG. 2, the first curved surface 302 and the second curved surface 304 are both convex surfaces.

As noted above, the spherical aberration phenomenon is caused by different focusing points of paraxial light ray 100 and peripheral light ray 102. According to this embodiment, to reduce the spherical aberration phenomenon, the optical lens 300 further includes an annular mask component 308 disposed on the first curved surface 302. As shown in FIG. 2 and FIG. 3, the annular mask component 308 has a ring structure where an aperture 310 is formed therein. The paraxial light ray 102 passing through the aperture 310 can transmit through the optical lens 300 and is converged at the focus point A. However, since a peripheral annular region of the optical lens 300 is shielded by the annular mask component 308, the peripheral light ray 100 is blocked by the annular mask component 308 and can not transmit through the peripheral region of the optical lens 300. Thus, only the paraxial light ray 102 is focused at the focus point A and the image focusing can be more accurate. Accordingly, the spherical aberration phenomenon caused by different focusing points of paraxial light ray 100 and peripheral light ray 102 can be reduced and the image sharpness can be enhanced. In one embodiment, the annular mask component 308 stretches from the edge 306 to the first curved surface 302 of the optical lens 300, thereby covering the entire peripheral region of the first curved surface 308.

In one embodiment, the annular mask component 308 can be any material that is selectively transmissive. In another embodiment, annular mask component 308 is opaque such that it can block light energy at the peripheral region of the optical lens 300. Most preferably, the annular mask component 308 is a black body which can absorb all incident electromagnetic radiation. One example of the annular mask component 308 is carbon film, but is not limited thereto. In another embodiment, the annular mask component 308 directly contacts the first curved surface 302 of the optical lens 300. Specifically, the annular mask component 308 is formed by coating appropriate material onto the first surface 302 of the optical lens 300.

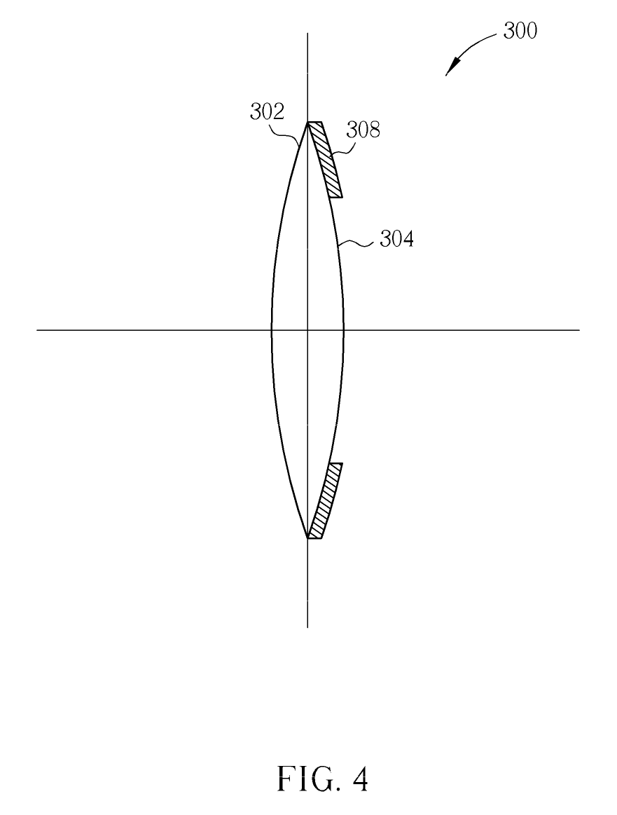

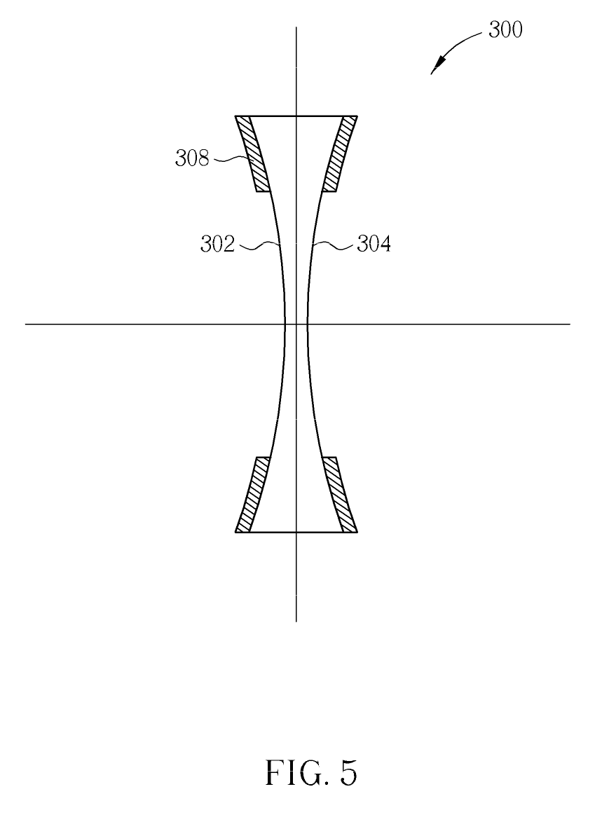

Please refer to FIG. 4 and FIG. 5 which illustrate schematic diagrams of the optical lens according to the second embodiment and the third embodiment of the present invention. As shown in FIG. 4, the annular mask component 308 is disposed on the second curved surface 304 instead of the first second curved surface 302. As shown in FIG. 5, the annular mask component 308 is disposed both on the first curved surface 304 and the second curved surface 304 of the optical lens 300. In this embodiment, the first curved surface 302 and the second curved surface 304 are concave surfaces. It should be noted that the position of the annular mask component 308 and the embodiment of the first curved surface 302 and the second curved surface 304 can be arbitrarily arranged wherein the arrangement combinations are not described in detail.

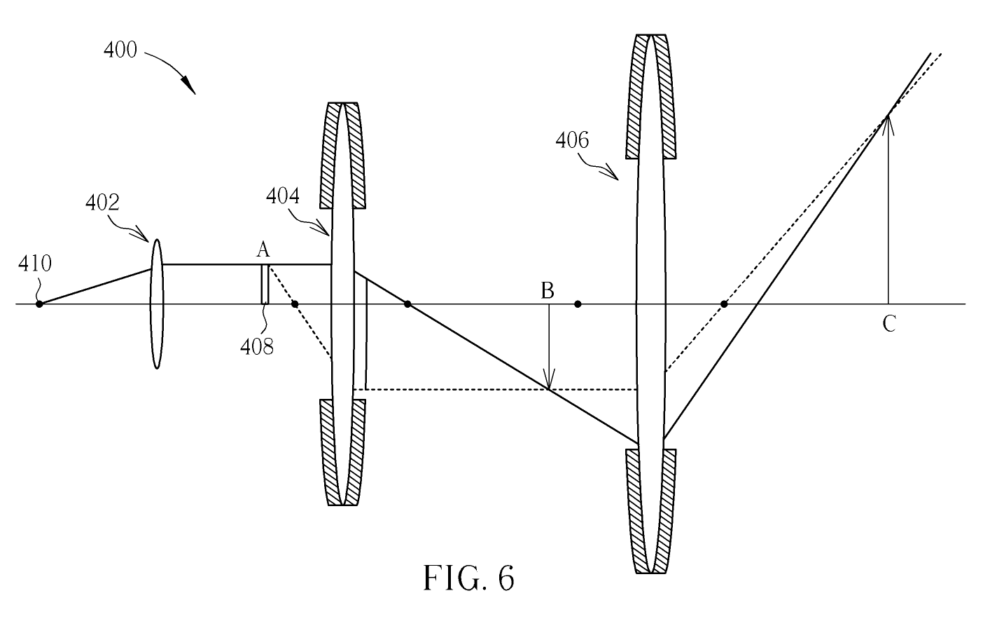

The optical lens 300 according to the present invention is applicable in any field of optical technology such as a microscope. FIG. 6 is a schematic diagram of an optical microscope system according to another aspect of the present invention. As shown in FIG. 6, the optical microscope system 400 in the present invention includes three optical lens which may include a condenser lens 402, an objective lens 404 and a projector lens 406. A specimen 408 is placed between the condenser lens 402 and the objective lens 404. The condenser lens 402 is utilized to convert a point source of light into collimated light while the magnification of the optical microscope 400 is determined by the objective lens 404 and the projector lens 406. For example, when parallel light is transmitted through the specimen 408 and refracted at the objective lens 404 and the projector lens 406, an enlarged image is generated at position C. To gain a clearer image, at least one of the condenser lens 402, objective lens 404 and projector lens 406 includes the annular mask component 308 covering their peripheral regions. In one embodiment, both the peripheral regions of the objective lens 404 and the projector lens 406 are covered by the annular mask components 308. The embodiment of the annular mask component 308 in the optical microscope 400 is similar to those mentioned-above. The spherical aberration phenomenon in the optical microscope 400 set forth in the present invention can be reduced and the resolution can be upgraded. However, it is understood that the present invention is not limited to the aforesaid optical microscope system but can also be applicable in an electron microscope system or other microscope systems.

Those skilled in the art will readily observe that numerous modifications and alterations of the device and method may be made while retaining the teachings of the invention.

What is claimed is:

1. An optical lens comprising:
a first curved surface; and
an annular mask component on and in direct contact with the first curved surface, wherein the annular mask component shields a peripheral annular region of the optical lens from entry of light.

2. The optical lens according to claim 1, wherein the annular mask component comprises an opaque material.

3. The optical lens according to claim 1, wherein the annular mask component comprises a carbon film.

4. The optical lens according to claim 1, wherein the first curved surface is a convex surface.

5. The optical lens according to claim 1, wherein the first curved surface is a concave surface.

6. The optical lens according to claim 1 further comprising a second curved surface opposite to the first curved surface.

7. The optical lens according to claim 6, wherein the second curved surface is a convex surface.

8. The optical lens according to claim 6, wherein the second curved surface is a concave surface.

9. An optical microscope system, comprising:
an objective lens comprising a first curved surface; and
a projector lens comprising a second curved surface, wherein at least one of the objective lens and the projector lens comprises an annular mask component on and in direct contact with the first curved surface or the second curved surface, and the annular mask component shields a peripheral annular region of the objective lens or the projector lens from entry of light.

10. The optical microscope system according to claim 9, further comprising a condenser lens comprising a third curved surface, wherein the annular mask component on and in direct contact with the third curved surface.
